(19) United States
(12) Patent Application Publication
(10) Pub. No.: US 2008/0111676 A1
(43) Pub. Date: May 15, 2008

(54) Dual alarm notification

(76) Inventor: Glenn Cris Dobbs, Tomball, TX (US)

Correspondence Address: Wisner & Associates, Suite 400, 1177 West Loop South, Houston, TX, 77027-9012, US

(21) Appl. No.: 11/599,667

(22) Filed: Nov. 15, 2006

(51) Int. Cl. G08B 29/00

(52) U.S. Cl. 340/506

(57) ABSTRACT

Apparatus and method for working with existing alarm monitoring systems to provide a second notification of an event at a remote location that is being monitored by the system that is directed to a law enforcement agency in the jurisdiction in which the remote location is located. As a result of this second, direct notification, the response time of the law enforcement agency is significantly reduced, increasing the likelihood that remedial action can be taken before injury or loss of life or damage to property.

### BACKGROUND OF THE INVENTION

The present invention relates to methods and systems for monitoring for events at remote locations. More specifically, the present invention relates to methods and systems for monitoring the premises at a location remote from a monitoring station for the occurrence of events that could be an indication of a security breach or other emergency.

With recent political and social changes in the world, security monitoring of remote premises has become an important and necessary business. With ever-increasing demands on law enforcement agencies, private business has played an increasingly significant role in securing both business and residential premises. Companies such as ADT (Atlanta, Ga.), Brink's Company (Richmond, Va.), and Protection One (Lawrence, Kans.) have enjoyed substantial growth as more and more private residences are monitored for the occurrence of events that could be an indication of a security breach or other emergency from a remote location, and those providers, and many other businesses, provide similar services, some of which are very sophisticated, for business and other premises. With the increasing importance of information in the business world, the information technology sector has become involved in business premises monitoring to both take advantage of the sophisticated electronics and software that have been developed for security purposes (technology that enables one to view multiple, real-time cameras at a remote location is now routine, for instance) and to utilize and protect using technologies such as high speed and wireless Internet and cellular communications.

In spite of the increasingly sophisticated hardware and software that is available for premises monitoring and security, except for those businesses that maintain their own private security forces and/or that essential to government services such that they are staffed with law enforcement personnel, there is a weak link in the remote monitoring system. Specifically, when an event that is indicative of a security breach or other emergency is detected, action needs to be taken to secure the premises. Although many other responses may also be set in motion by detection of such an event, the action that must be taken to secure the premises usually involves a premises visit by a law enforcement officer who is stationed at the law enforcement agency in the particular location in which the premises are located. In a true emergency, the time that elapses between detection of the event and the arrival of the law enforcement officer on the premises is critical, and any reduction in this response time is a desirable goal when premises are being monitored from a remote location.

The length of the response time is influenced by several factors. If one considers, for instance, common residential alarm monitoring services such as those provided by the afore-mentioned ADT, Brinks, and/or Protection One, the occurrence of the event is detected by the monitoring company, at which time the company attempts to reach persons on premises by telephone call. Depending upon the results of that telephone call, the monitoring company may then notify the dispatcher of the local law enforcement agency, after which the law enforcement agency dispatches an officer to the premises. Delays may occur at each and/or all of these steps to the point that it is not uncommon for the law enforcement officer to arrive at the premises for several minutes or even hours after the event is detected. Of course even a few minutes is more than enough time for occurrence of damage to the premises or injury to persons living or working on the premises such that, although such companies provide valuable services, the value of their services can be compromised by the nature of the on-premises event(s) that trigger the response and the time it takes to respond to that/those event(s).

It is, therefore, an object of the present invention to provide a method and system for reducing the time between occurrence of an event that may be indicative of a security breach or other emergency at a remote location and a visit by a law enforcement officer to the premises.

Another object of the present invention is to provide a method and system that works with existing remote alarm monitoring systems to reduce response time.

Another object of the present invention is to provide a system and method for outputting two or more notifications of an event that may be indicative of a security breach or other emergency at a remote location.

Another object of the present invention is to provide a system and method for direct notification of a law enforcement agency upon detection of an event that may be indicative of a security breach or other emergency at a remote location.

Yet another object of the present invention is to provide a system and method for direct notification of a law enforcement agency upon detection of an event that may be indicative of a security breach or other emergency at a remote location that provides information as to the type of event that was detected.

Another object of the present invention is to provide a system and method for producing two signals upon detection of an event that may be indicative or a security breach or other emergency at a remote location, the first signal being routed to an alarm monitoring company for the purpose of enabling the alarm monitoring company to handle the signal in the manner in which other incoming signals are handled, and the second signal being likewise routed to a monitoring company for the purpose of directly notifying a the law enforcement agency in the jurisdiction in which the remote location is located if the detection of the event, thereby reducing the time that elapses from detection of the event until a responding law enforcement officer arrives at the remote location.

This list of several of the objects of the present invention is not intended to be all-inclusive. Other objects, and the advantages, of the present invention will be made clear to those skilled in the art by the following description of several embodiments thereof.

### SUMMARY OF THE INVENTION

These objects, and many others, are met in the present invention by providing a method of monitoring an alarm system at a remote location for the occurrence of an event triggering an alarm, the remote location being provided with one or more sensors for detecting the event and outputting an electrical signal to an alarm monitoring station upon detection of the event, comprising the steps of detecting the signal output from the sensor located at the remote location with a receiver, the receiver outputting a signal to a server, matching the signal output from the receiver to an account stored in a database in the server, the account including information identifying both the law enforcement agency in the jurisdiction in which the remote location is located and the alarm system at the remote location, and outputting a first signal to the central alarm station operated by the monitor of the alarm system at the remote location in accordance with the information in the account to which the output signal from the receiver is matched. Likewise, a second signal is also output from the alarm system at the remote location to a monitoring company for the purpose of notifying a law enforcement agency for the jurisdiction in which the remote location is located, the second output signal including information as to the location of the remote location and the identity of the law enforcement agency in which the remote location is located, in accordance with the information in the account to which the output signal from the receiver is matched. The second signal is preferably output concurrently with, or at least as approximately the same time, as the first signal, hence the present invention is conveniently referred to as a system or process for dual alarm notification.

### BRIEF DESCRIPTION OF THE DRAWINGS

FIG. 1 is a schematic diagram of a representative type of known alarm monitoring system.

FIG. 2 is a schematic diagram of the integration of the known alarm system of FIG. 1 with the dual alarm notification system of the present invention.

### DETAILED DESCRIPTION OF THE PREFERRED EMBODIMENTS

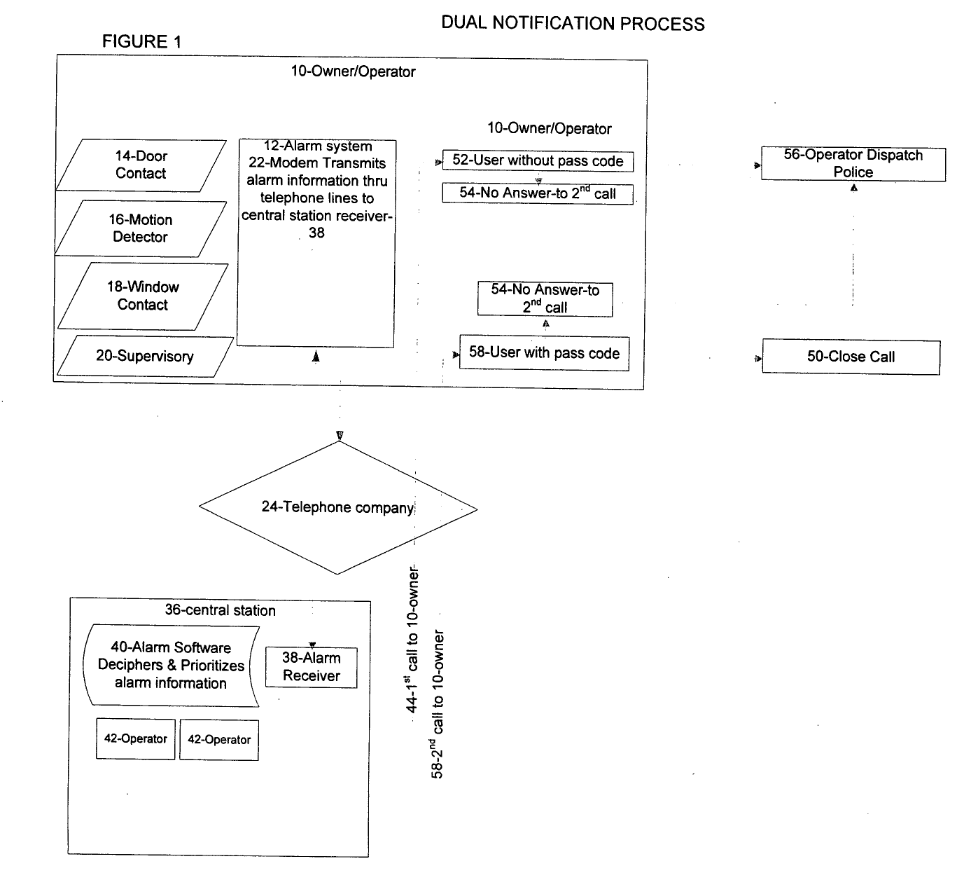

Referring now to the figures, the present invention is best understood with reference to an existing remote alarm monitoring system of a type such as that shown in FIG. 1. In the case of an existing monitoring system, a plurality of detectors, each of the type that output a signal, are located at a home or business and comprise part of what may be referred to as the “on-premises alarm system” 10. The on-premises alarm system 10 includes a control panel 12 and may be comprised of several detectors, such as intrusion/door detector(s) 14, motion detector(s) 16, window detector(s) 18, and an input 20 (usually in the form of a keypad) for supervisory and other functions. The alarms system 10 may also include a so-called “panic button” (sometimes integrated into the keypad) and fire and/or smoke detectors (not shown). Control panel 12 includes hardware for processing and forwarding signals through a telephone modem 22 to a remote monitoring company 34 (see below). In addition to the supervisory keypad 20, the on-premises system 10 also includes hardware and software (not shown) for detecting low battery, phone line loss, detector malfunction, etc. that also produces an output to the monitoring company. Upon detection of an event, or primary alarm 22, an on-premises alarm system of the type shown at reference numeral 12 transmits a signal via the telephone company 24 into which the alarm system 12 is tied and to which the owner and/or operator of the home or business 10 subscribes. Those skilled in the art who have the benefit of this disclosure will recognize that the primary alarm signal can be transmitted via standard telephone service and/or via cellular alarm communicator, and that the alarm system may also include backup capability, for instance, by routing an additional call to the monitoring company through the cellular alarm communicator/cell provider to which the owner and/or operator of the home or business 10 subscribes. The call is received by the monitoring company that operates a so-called central station 36 that includes an alarm receiver 38. The alarm receiver 38 is provided with alarm software 40 of a type known in the art and available commercially that deciphers and prioritizes the incoming call from the alarm system 10. Fire is generally regarded as the highest priority, even over an intrusion alarm signal, by such alarm monitoring companies; the signals are viewed by an operator 42 employed by or contracted to the monitoring company on a computer display (not shown) for appropriate action by the operator.

In conventional remote alarm monitoring systems such as that shown in FIG. 1, upon receipt of an intrusion alarm (fire alarms are generally routed directly to the fire station located near the premises at which the alarm system is located), operator 42 places a first call 44 to the home/business at which the alarm system 10 is located, giving rise to three possibilities. The person who answers the first call 44 may have the password 48 for that particular account, in which case, the call is closed 50. However, the person who answers the first call 44 may not know the account password 52; alternatively, the first call 44 may not be answered 54. If the person who answers does not know the account password, operator 42 notifies the police or other law enforcement agency 56 for the jurisdiction in which the home/business 10 is located. If no answer, the operator 42 makes a second call 58 to the home/business 10 and operator 42 then either closes the call 50 or notifies the law enforcement agency 56 depending upon the results of that second call 58.

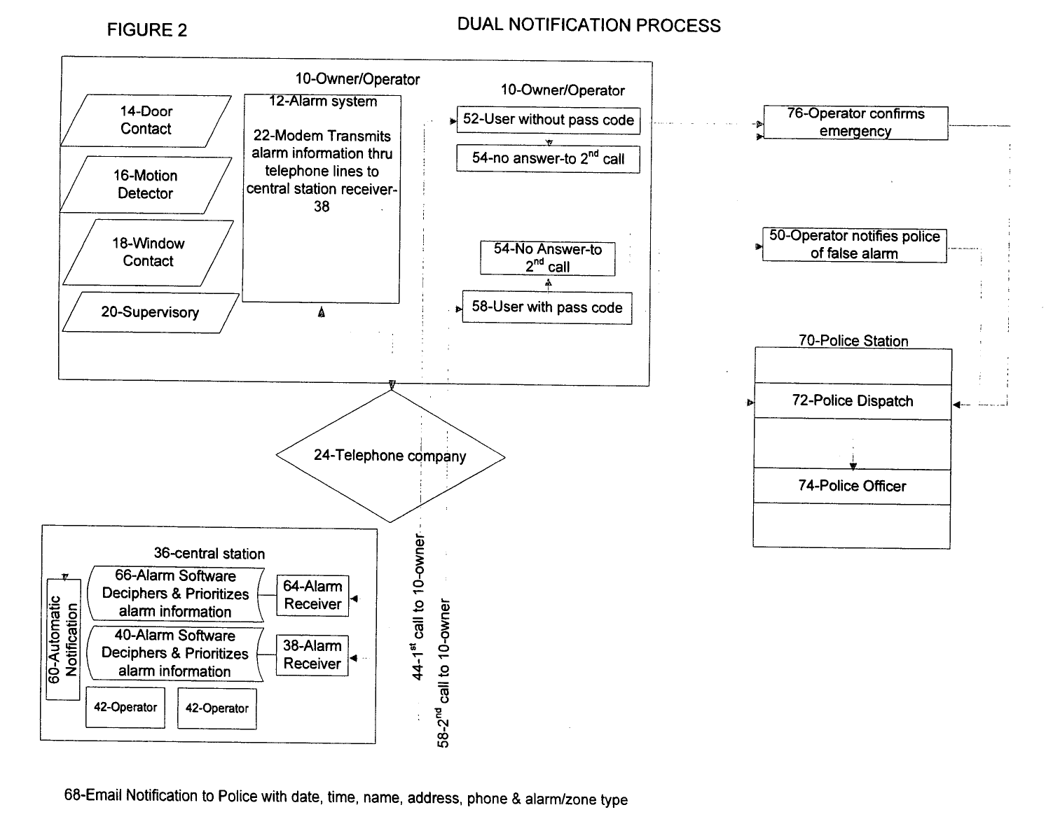

The integration of the dual alarm notification system of the present invention with an existing alarm system of the type shown in FIG. 1 is shown in FIG. 2. As shown in FIG. 2, the notification 68 produced by the alarm software 66 of the system of the present invention and the notification 56 from the operator 42 of the monitoring company both arrive at the police station dispatcher 72. The difference, and the consequent reduction in response time resulting from the present invention, is in the time that elapses between the time T₁ when the event is detected by, for instance, the motion detector 16 at the premises at which alarm system 10 is located and the time T₂ when the police dispatcher 72 receives notification 56 (from an alarm system of the type shown in FIG. 1) and the notification 68 (from the dual notification system of the present invention). This difference in times T₁ and T₂ is such that when the system of the present invention is combined with an existing system as shown in FIG. 2, the call from the operator 42 of monitoring company confirms an emergency 76 rather than notifies of the emergency that has already caused the dispatcher 72 to send a police officer 74 to the premises at which the alarm system 10 is located. Experience with prior known methods and systems indicates that in the case of conventional remote monitoring systems of the type shown in FIG. 1, this difference between times T₁ and T₂ varies from about a minute to as long as several minutes, and in some isolated cases, portions of an hour. In the case of the method and system of the present invention, it has been found that the time that elapses between times T₁ and T₂ is generally less than one minute, and sometimes the time that elapses between times T₁ and T₂ can be measured in seconds.

Referring now specifically to FIG. 2, the present invention is described as follows. Most alarm control panels 12 that comprise an alarm system 10 are provided with the capability to make two (or even more) calls to different telephone numbers. In the method of the present invention, the first call output from the alarm system 10 through telephone company 24 is to the remote monitoring company for handling in the manner described above. The second call (and note that the first and second calls are designated as being first and second herein as a way to differentiate between calls and not because they are necessarily made in that sequence; to the contrary, many control panels have the capacity to make both calls so quickly that the two calls are, in effect, simultaneous) from the alarm system 10 through phone company 24 is to the operator 60 of the system of the present invention. Those skilled in the art who have the benefit of this invention will recognize that the calls that are output from alarm system 10 are shown in the figures as being accomplished over telephone service with the alarm system modem being tied into a conventional two conductor telephone line at the home or business at which alarm system 10 is located to transmit the alarm signal in a manner that is similar to the manner in which a fax machine sends data or a dial-up modem transmits data between a computer and a host server over the Internet. The output from alarm system 10 to either of the remote monitoring company or the operator 60 of the method of the present invention is also accomplished via cell phone or radio frequency (RF) transmission. The cellular device or RF transmitter may also be connected to the two-conductor telephone line so that in the event telephone service is lost (for instance, by a burglar who cuts the telephone line), the cellular device takes over and transmits the alarm signal. Cell communication backups that emulate a dial tone or telephone line and provide full data communication for the alarm system are known in the art. In an alternative embodiment contemplated by the method and system of the present invention, the output from alarm system 12 to remote monitoring company 60 is also accomplished by VOIP, implemented with IP modules at the home/business at which the alarm system 10 is located and remote monitoring company and/or operator 60 and broadband modem(s) for transmission over the Internet and/or over municipal (or other) wireless network.

As shown in FIG. 2, the second call from the on-premises alarm system 10 is received by the remote monitoring company 60 of the system of the present invention at a remote location 62. The signal is received at alarm receiver 64 and processed by the alarm software 66 that resides on a computer (not shown) operated by company 60. Alarm software 66 functions to produce an output notification from the remote monitoring company 60 directly to the police/law enforcement agency 56 in the jurisdiction in which the home/business at which alarm system 10 is located. The output notification is received, for instance, at a police station 70 by a dispatcher 72, who dispatches a responding police officer 74. Although other alternatives are available and specifically contemplated by the present invention such that the invention is not limited in its scope to e-mail, in the presently preferred embodiment, this output notification takes the form of a pre-formatted e-mail from monitoring company 60 that is sent to the police/law enforcement agency 56 that includes the address of the premises at which alarm system 10 is located, the type of alarm, the identify of the owner/occupant of the premises, any other useful and/or required information as may be helpful or necessary to the law enforcement officer, the owner/occupant of the premises, and/or monitoring company 60.

As described above, the output from alarm system 12 to operator 60 is detected by an alarm receiver 64 at the remote location 62. Alarm receiver 64 is available commercially from such vendors as Honeywell (FBI, Ademco SILENT KNIGHT) and General Electric (Osborne-Hoffman OH-2000, GE/Caddx, ITI), and is designed to receive, display, and route data with programmable phone line settings that is comprised of a master central processor and one or more line cards (not shown) that is/are connected to a server (not shown). The line cards support caller ID and Caller Name Delivery and are individually programmable for format priority and ring parameters.

The alarm software 66 that resides on the server is available commercially under the trademarks and/or from vendors such as ADSW-NT Software, Microkey (Kissimmee, Fla.), ALARM CENTER (Security Information Systems, Inc. (Orlando, Fla.)), and Patriot (Dowagiac, Mich.). Such software picks up the call from the alarm panel 12 of the on-premises alarm system 12 and queries the control panel for the particular code/I.D. number assigned to that control panel. If the code/I.D. is recognized by software 66, the server on which software 66 resides accepts information from the control panel 12 identifying the contact and/or zone from which the signal originates and matches that information to the appropriate account stored in the database residing on the server. Included in the account information is the identity of the law enforcement agency 56 in the jurisdiction in which the premises at which alarm system 10 is located and, if the alert/output notification is accomplished by e-mail in the presently preferred embodiment described above, the e-mail address of law enforcement agency 56 so that the software generates that e-mail without intervention by operator 60.

Although described in terms of the embodiments shown in the figures, these embodiments are shown to exemplify the present invention and not to limit the scope of the invention, it being recognized by those skilled in the art that certain changes can be made to the specific structure of the embodiments shown and described without departing from the spirit of the present invention. All such modifications, and other modifications that do not depart from the spirit of the present invention, are intended to fall within the scope of the following claims.

What is claimed is:

1. A method of monitoring the alarm system at a remote location for the occurrence of an event triggering an alarm, the remote location being provided with one or more sensors for detecting the event and outputting a signal to an alarm system central monitoring station upon detection of the event, comprising the steps of:
detecting the signal output from the sensor located at the remote location with a receiver, the receiver being operably connected to a server;
outputting a signal from the sensor to a central alarm station operated by the remote monitor of the alarm system at the remote location for processing in accordance with procedures set by the operator of the central alarm station;
matching the signal output from the receiver to an account stored in a database in the server, the account including information identifying both the law enforcement agency in the jurisdiction in which the remote location is located and the remote location of the alarm system;
outputting a signal from the server to the law enforcement agency for the jurisdiction of the remote location with the information in the account to which the output signal from the receiver is matched.

2. The method of claim 1 wherein the alarm system at the remote location includes one or more sensors and the signal output to the law enforcement agency includes information as to the particular sensor outputting the event signal.

3. The method of claim 1 additionally comprising paging one or more devices selected from the group consisting of pagers, land-line telephones, wireless telephones, radios, and computers.

4. The method of claim 1 wherein all signals detected by the receiver are logged to the account to which the signals are matched for reporting purposes.

5. The method of claim 1 wherein the signal output by the sensor at the remote location is transmitted to the receiver either by land-line telephone, cellular telephone, radio, radio telephone, or computer network.
